(19) United States
(12) Patent Application Publication
(10) Pub. No.: US 2010/0249982 A1
(43) Pub. Date: Sep. 30, 2010

(54) DISPLACEMENT COMPENSATION CONTROL METHOD AND MODULE FOR AN OBJECT MOUNTED MOVABLY ON A DRIVING ROD UNIT

(75) Inventors: Paul CHANG, Taichung County (TW); Tsair-Rong CHEN, Changhua County (TW); Jeen-Sheen ROW, Miaoli County (TW); Yuan-Fu TSAI, Taichung County (TW)

Correspondence Address: MCNEES WALLACE & NURICK LLC, 100 PINE STREET, P.O. BOX 1166, HARRISBURG, PA, 17108-1166, US

(73) Assignees: BUFFALO MACHINERY COMPANY LIMITED, Taichung County (TW); THE DEPARTMENT OF ELECTRICAL ENGINEERING, NATIONAL CHANG-HUA UNIVERSITY OF EDU, Changhua County (TW)

(21) Appl. No.: 12/409,845

(22) Filed: Mar. 24, 2009

(51) Int. Cl. G06F 19/00; F16H 21/00

(52) U.S. Cl. 700/193; 74/27

(57) ABSTRACT

In a displacement compensation control method and module for an object mounted movably on a driving rod unit and movable between first and second positions relative to the driving rod unit during processing, a detecting unit determines a displacement amount of a free end of the driving rod unit from a reference position in an axial direction of the driving rod unit as a result of thermal deformation of the driving rod unit during high-speed rotation. A control unit controls the driving rod unit to rotate based on the displacement amount so that the object moves between first and second compensation positions relative to the driving rod unit. A distance between the first position and the first compensation position, and a distance between the second position and the second compensation position are equal to the displacement amount.

### BACKGROUND OF THE INVENTION

1. Field of the Invention

The invention relates to a displacement compensation control method and module, more particularly to a displacement compensation control method and module for an object mounted movably on a driving rod unit.

2. Description of the Related Art

For a conventional high-speed machining apparatus, a ballscrew mounted with a workbench thereon easily deforms as a result of thermal expansion during processing. Therefore, accuracy of a workpiece being machined by the conventional machining apparatus cannot be ensured. Accordingly, a cooling system is needed to reduce a temperature of the ballscrew.

However, since the cooling system requires a relatively long response time to reduce the temperature of the ballscrew, the cooling system cannot eliminate thermal deformation of the ballscrew in time. Furthermore, implementation of the cooling system incurs a relatively high cost.

### SUMMARY OF THE INVENTION

Therefore, an object of the present invention is to provide a displacement compensation control method and module for an object mounted movably on a driving rod unit that can overcome the aforesaid drawbacks of the prior art.

According to one aspect of the present invention, there is provided a displacement compensation control method for an object mounted movably on a driving rod unit. The driving rod unit is rotatable so as to move the object between first and second positions relative to the driving rod unit during processing. The displacement compensation control method comprises the steps of:

a) determining a displacement amount of a free end of the driving rod unit from a reference position in an axial direction of the driving rod unit as a result of thermal deformation of the driving rod unit during high-speed rotation; and

b) based on the displacement amount determined in step a), controlling the driving rod unit to rotate so that the object moves between a first compensation position and a second compensation position relative to the driving rod unit, the first position being disposed between the free end of the driving rod unit and the first compensation position, the second position being disposed between the free end of the driving rod unit and the second compensation position, a distance between the first position and the first compensation position, and a distance between the second position and the second compensation position being equal to the displacement amount of the free end of the driving rod unit.

According to another aspect of the present invention, there is provided a displacement compensation control module for an object mounted movably on a driving rod unit. The driving rod unit is rotatable so as to move the object between first and second positions relative to the driving rod unit during processing. The driving rod unit has a rotatable coupling end, and a free end opposite to the coupling end in an axial direction of the driving rod unit. The displacement compensation control module comprises:

a detecting unit adapted for determining a displacement amount of the free end of the driving rod unit from a reference position in the axial direction as a result of thermal deformation of the driving rod unit during high-speed rotation; and

a control unit coupled to the detecting unit and adapted to control the driving rod unit to rotate based on the displacement amount determined by the detecting unit so that the object moves between a first compensation position and a second compensation position relative to the driving rod unit, the first position being disposed between the free end of the driving rod unit and the first compensation position, the second position being disposed between the free end of the driving rod unit and the second compensation position, a distance between the first position and the first compensation position, and a distance between the second position and the second compensation position being equal to the displacement amount of the free end of the driving rod unit.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary, partly schematic sectional view showing the preferred embodiment of a displacement compensation control module for an object mounted movably on a driving rod unit according to the present invention;

FIG. 2 is a schematic circuit block diagram illustrating the preferred embodiment;

FIG. 3 is a fragmentary, partly schematic sectional view showing another arrangement of a reference piece and a sensor of the preferred embodiment; and

FIG. 4 is a flow chart illustrating a displacement compensation control method performed by the displacement compensation control module of the preferred embodiment.

### DETAILED DESCRIPTION OF THE PREFERRED EMBODIMENT

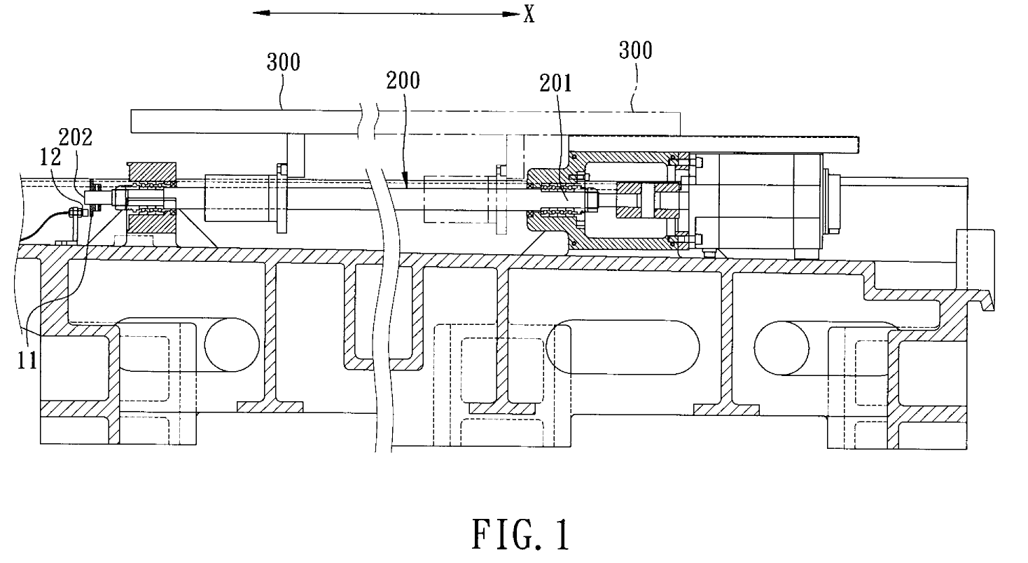

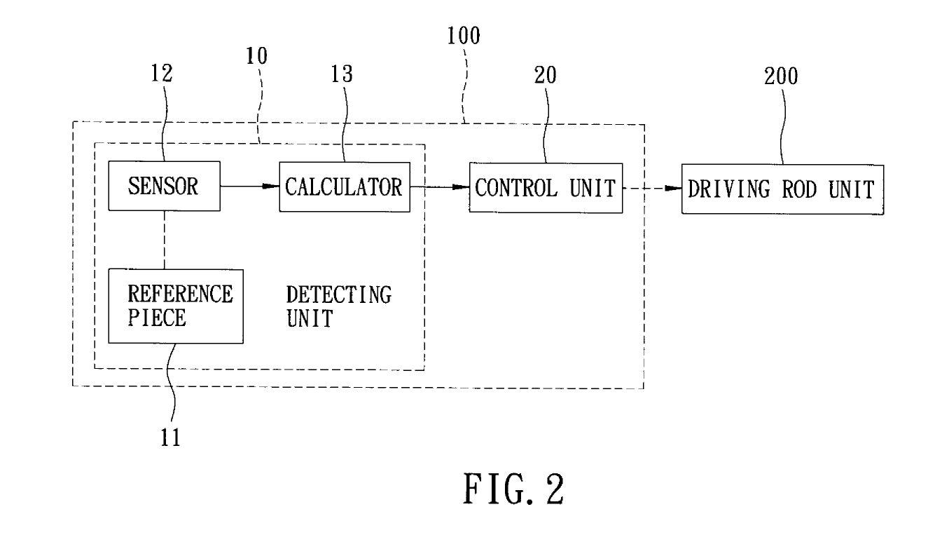

Referring to FIGS. 1 and 2, the preferred embodiment of a displacement compensation control module 100 for an object 300 mounted movably on a driving rod unit 200 according to the present invention is shown to include a detecting unit 10 and a control unit 20. In this embodiment, the object 300 is a workbench of a machining apparatus for mounting a workpiece to be machined by the machining apparatus thereon, and the driving rod unit 200 is a ballscrew. The driving rod unit 200 is rotatable so as to move the object 300 between first and second positions relative to the driving rod unit 200 during processing. The driving rod unit 200 has a rotatable coupling end 201, and a free end 202 opposite to the coupling end 201 in an axial direction (X) of the driving rod unit 200.

The detecting unit 10 is adapted for determining a displacement amount (d₁) of the free end 202 of the driving rod unit 200 from a reference position in the axial direction (X) as a result of thermal deformation of the driving rod unit 200 during high-speed rotation. In this embodiment, the detecting unit 10 includes a reference piece 11, a sensor 12, and a calculator 13.

The reference piece 11 is adapted to be mounted fixedly on the free end 202 of the driving rod unit 200.

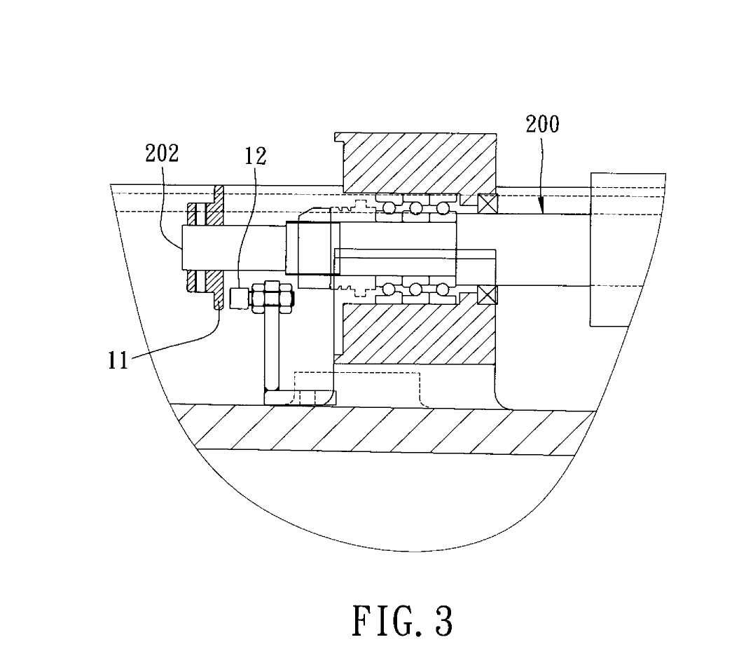

The sensor 12 is disposed adjacent to and is spaced apart from the reference piece 11 for sensing movement of the reference piece 11 in the axial direction (X) during processing so as to output a voltage output (Vₒ) corresponding to a displacement amount of the reference piece 11 that is substantially equal to the displacement amount (d₁) of the free end 202 of the driving rod unit 200. The reference piece 11 is disposed between the sensor 12 and the coupling end 201 of the driving rod unit 200, as shown in FIG. 1. Alternatively, the sensor 12 can be disposed between the reference piece 11 and the coupling end 201 of the driving rod unit 200, as shown in FIG. 3.

In this embodiment, the reference piece 11 is a conductor, and the sensor 12 is an eddy current sensor. As such, during processing, the eddy current sensor generates a voltage difference serving as the voltage output (Vₒ) in response to variation of an eddy current induced in the conductor with a magnetic field generated by the eddy current sensor. It is noted that the displacement amount of the conductor has a linear relation to the voltage difference.

The calculator 13 is coupled to the sensor 12 for receiving the voltage output (Vₒ) therefrom, and calculates the displacement amount (d₁) of the free end 202 of the driving rod unit 200 based on the voltage output (Vₒ), a predetermined deformation parameter (L), and a predetermined voltage parameter (V) having a linear relation to the predetermined deformation parameter (L) As a result, the displacement amount (d₁) can be expressed as

$${d}_{1} = L \times \frac{{V}_{0}}{V} .$$

For example, when L=2 μm and V=0.02 volt,

$${d}_{1} = 2 µm \times \frac{{V}_{0}}{0.02 volt} .$$

The control unit 20 is coupled to the calculator 13 of the detecting unit 10, and is adapted to control the driving rod unit 200 to rotate based on the displacement amount (d₁) determined by the calculator 13 so that the object 300 moves between a first compensation position and a second compensation position relative to the driving rod unit 200. The first compensation position is disposed between the free end 202 of the driving rod unit 200 and the first position. The second compensation position is disposed between the free end 202 of the driving rod unit 200 and the second position. A distance between the first position and the first compensation position, and a distance between the second position and the second compensation position are equal to the displacement amount (d₁) of the free end 202 of the driving rod unit 200.

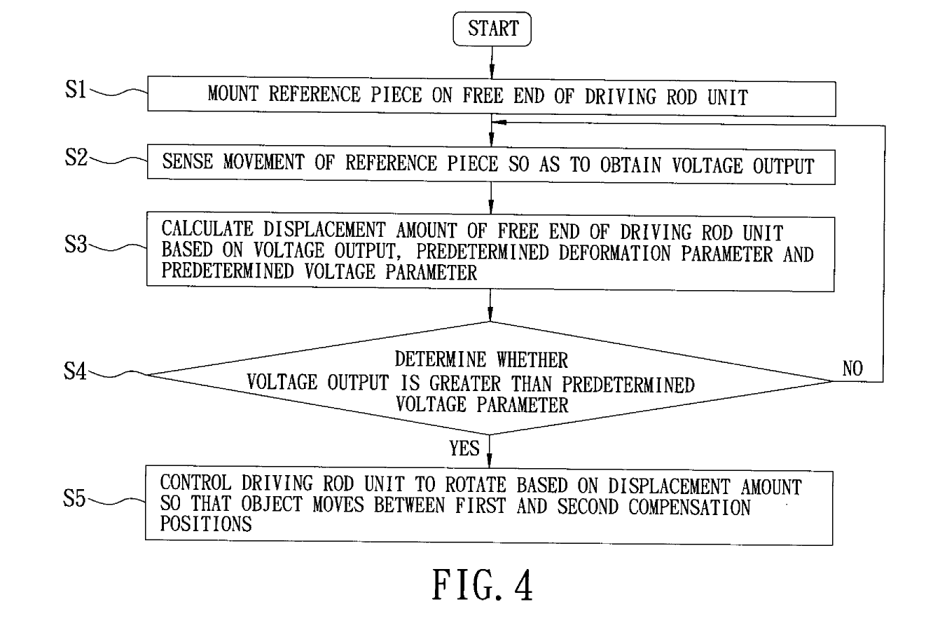

FIG. 4 is a flow chart illustrating a displacement compensation control method performed by the displacement compensation control module 100 of the preferred embodiment.

In step S1, the reference piece 11 is mounted on the free end 202 of the driving rod unit 200.

In step S2, the sensor 12 senses movement of the reference piece 11 in the axial direction (X) during processing so as to obtain the voltage output (Vₒ) corresponding to the displacement amount of the reference piece 11 that is substantially equal to the displacement amount (d₁) of the free end 202 of the driving rod unit 200.

In step S3, the calculator 13 calculates the displacement amount (d₁) of the free end 202 of the driving rod unit 200 based on the voltage output (Vₒ) the predetermined deformation parameter (L) and the predetermined voltage parameter (V).

In step S4, the control unit 20 determines whether the voltage output (Vₒ) obtained in step S2 is greater than the predetermined voltage parameter (V). If affirmative, the flow proceeds to step S5. Otherwise, the flow goes back to step S2.

In step S5, the control unit 20 controls the driving rod unit 200 to rotate based on the displacement amount (d₁) calculated in step S3 so that the object 300 moves between the first compensation position and the second compensation position.

In sum, due to the presence of the reference piece 11 and the sensor 12, the displacement compensation control module 100 of this invention can accurately and timely control the driving rod unit 200 so that the object 300 moves between the first and second compensation positions. Therefore, accuracy of the workpiece being machined can be ensured. Furthermore, implementation of the displacement compensation control module 100 of this invention incurs relatively lower costs as compared to the aforesaid cooling system of the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A displacement compensation control method for an object mounted movably on a driving rod unit, the driving rod unit being rotatable so as to move the object between first and second positions relative to the driving rod unit during processing, said displacement compensation control method comprising the steps of:
a) determining a displacement amount of a free end of the driving rod unit from a reference position in an axial direction of the driving rod unit as a result of thermal deformation of the driving rod unit during high-speed rotation; and
b) based on the displacement amount determined in step a), controlling the driving rod unit to rotate so that the object moves between a first compensation position and a second compensation position relative to the driving rod unit, the first position being disposed between the free end of the driving rod unit and the first compensation position, the second position being disposed between the free end of the driving rod unit and the second compensation position, a distance between the first position and the first compensation position, and a distance between the second position and the second compensation position being equal to the displacement amount of the free end of the driving rod unit.

2. The displacement compensation control method as claimed in claim 1, wherein step a) includes the sub-steps of:
a-1) mounting a reference piece on the free end of the driving rod unit;
a-2) sensing movement of the reference piece in the axial direction of the driving rod unit during processing so as to obtain a voltage output corresponding to a displacement amount of the reference piece that is substantially equal to the displacement amount of the free end of the driving rod unit; and
a-3) based on the voltage output, a predetermined deformation parameter, and a predetermined voltage parameter having a linear relation to the predetermined deformation parameter, calculating the displacement amount of the free end of the driving rod unit.

3. The displacement compensation control method as claimed in claim 2, wherein step a) further includes the sub-step of:
a-4) determining whether the voltage output obtained in sub-step a-2) is greater than the predetermined voltage parameter; and
wherein step b) is performed only when it is determined in sub-step a-4) that the voltage output obtained in sub-step a-2) is greater than the predetermined voltage parameter.

4. A displacement compensation control module for an object mounted movably on a driving rod unit, the driving rod unit being rotatable so as to move the object between first and second positions relative to the driving rod unit during processing, the driving rod unit having a rotatable coupling end, and a free end opposite to the coupling end in an axial direction of the driving rod unit, said displacement compensation control module comprising:
a detecting unit adapted for determining a displacement amount of the free end of the driving rod unit from a reference position in the axial direction as a result of thermal deformation of the driving rod unit during high-speed rotation; and
a control unit coupled to said detecting unit and adapted to control the driving rod unit to rotate based on the displacement amount determined by said detecting unit so that the object moves between a first compensation position and a second compensation position relative to the driving rod unit, the first position being disposed between the free end of the driving rod unit and the first compensation position, the second position being disposed between the free end of the driving rod unit and the second compensation position, a distance between the first position and the first compensation position, and a distance between the second position and the second compensation position being equal to the displacement amount of the free end of the driving rod unit.

5. The displacement compensation control module as claimed in claim 4, wherein said detecting unit includes:
a reference piece adapted to be mounted fixedly on the free end of the driving rod unit;
a sensor disposed adjacent to and spaced apart from said reference piece for sensing movement of said reference piece in the axial direction during processing so as to output a voltage output corresponding to a displacement amount of said reference piece that is substantially equal to the displacement amount of the free end of the driving rod unit; and
a calculator coupled to said sensor for receiving the voltage output therefrom, and calculating the displacement amount of the free end of the driving rod unit based on the voltage output, a predetermined deformation parameter, and a predetermined voltage parameter having a linear relation to the predetermined deformation parameter.

6. The displacement compensation control module as claimed in claim 5, wherein said reference piece is a conductor, and said sensor is an eddy current sensor.
